(19) United States
(12) Patent Application Publication
(10) Pub. No.: US 2014/0329074 A1
(43) Pub. Date: Nov. 6, 2014

(54) REACTIVE POLYOLEFIN HOT-MELT ADHESIVE HAVING LOW VISCOSITY AND USE THEREOF FOR TEXTILE LAMINATIONS

(71) Applicant: SIKA TECHNOLOGY AG, Baar (CH)

(72) Inventors: Doreen Janke, Alveslohe (DE); Mathias Cordes, Hamburg (DE)

(73) Assignee: SIKA TECHNOLOGY ag, Baar (CH)

(21) Appl. No.: 14/357,693

(22) PCT Filed: Dec. 18, 2012
(86) PCT No.: PCT/EP2012/075933

§ 371 Date: May 12, 2014

(30) Foreign Application Priority Data
Dec. 19, 2011 (EP) 11194299.1

(51) Int. Cl. C09J 123/26; B32B 37/12; B32B 7/12

(52) U.S. Cl. CPC C09J 123/26; B32B 7/12; B32B 37/1207; B32B 2037/1215
USPC 428/221; 428/447; 428/317.7; 428/429; 428/424.8; 524/261; 156/60; 156/322

(57) ABSTRACT

The invention relates to hot-melt adhesive compositions having at least one thermoplastic poly-a-olefin that is solid at 25° C. and that contains silane groups, at least one soft resin having a melting point or softening point between −10 and 40° C., and at least one silane that is liquid at 25° C. The hot-melt adhesive compositions are characterized by an improved open time and reduced viscosity compared to the prior art that cannot be achieved by means of other low-molecular-weight components that are normally added to reduce the viscosity, because the components escape from the adhesive formulation over time. The hot-melt adhesives according to the invention are suitable in particular as laminating adhesives and have a desirable low viscosity during the application, while good cross-linking density can be achieved by the addition of silane that is liquid at room temperature. Despite the extended open time, the hot-melt adhesive compositions quickly build up an extremely high early strength and lead to a heat-stable adhesive bond.

### PRIOR ART

Hot-melt adhesives for use as lamination adhesives have been known for a long time. However, when the molten adhesive is applied in a thin layer to a support material, the problem frequently is that these adhesives have a short open time leading to excessively rapid cooling of the applied adhesive and in the process to its solidification. As a result, the adhesive is no longer able to wet the surface of the joining partner, so that an adhesive bond can no longer form. This effect is a problem particularly in the case of hot-melt adhesives that are based on amorphous thermoplastic polymers. An additional disadvantage of this type of hot-melt adhesives is that the adhesives remain thermoplastic even after the application. When heating an adhesive bond based on such adhesives, the adhesive consequently can melt again and the bond can be destroyed when exposed to a load.

An additional disadvantage of known thermoplastic hot-melt adhesives is that they are very hard (i.e., not bendable or flexible) in the cured state, which is in conflict with their use for textile laminations, particularly in the clothing sector. In the case of textile uses, the user wants a “soft touch,” i.e., to the extent possible the adhesive should not be perceivable. In addition, polyolefin-based hot-melt adhesives in particular require high melting temperatures, so that such adhesives are not suitable for heat-sensitive materials, such as, for example, thin polyurethane membranes in the textile sector. Finally, in textile applications in the clothing sector, there is the problem that the textiles have to be washed frequently, so that the adhesives must have a high heat resistance in order to be able to withstand the stresses of washing processes.

In the prior art, these problems are solved with reactive hot-melt adhesives in which, during the cooling phase of the adhesive, a crosslinking of the molten adhesive occurs and therefore duroplastic properties are conferred to the hot-melt adhesive. The prior art for textile bonding consists of low-viscosity polyurethane hot-melt adhesives which react with moisture from the environment after the application and crosslink thus forming heat-stable bonding. These adhesives are soft and sufficiently flexible even at 25° C. and they have a very low melting point, which allows the application to heat-sensitive substrates. However, one problem of these adhesives is that they are exceedingly soft immediately after the application and they develop their strength only over a longer time period. Reactive polyurethane hot-melt adhesives therefore have a long open time, particularly if they are applied in thin layers, but only a low initial strength. Moreover, such adhesives frequently have residual monomeric isocyanate contents of more than 1%, so that they have to be labeled R40 (suspected carcinogenic effect) according to the current labeling regulations.

An additional class of reactive hot-melt adhesives is based on silane-grafted poly-α-olefins, as described in U.S. Pat. No. 5,994,474 or DE 40 00 695 A1, for example. These hot-melt adhesives achieve a very high strength with high heat stability and they also have a very high initial strength.

Corresponding adhesives have been described in the more recent past in particular for applications on glass surfaces. Thus, for example, WO 2004/081138 A1 describes hot-melt adhesives based on silane functional poly-α-olefins that are combined with tackifiers and thermoplastic elastomers. The tackifiers in the compositions according to WO 2004/081138 have softening points of more than 60° C. The corresponding adhesives are described as advantageous sealing materials in window construction or the bonding of several glass layers.

In WO 2011/109605 A1, moisture-curing adhesive systems based on silane functional poly-α-olefin polymers, thermoplastic components having a softening point above 120° C., silane-based tackiness improving agents as well as thermoplastic tackifying resins having a softening point above 80° C. These adhesives were used for the construction of solar modules, particularly for sealing and suspension frames of solar modules.

Finally, WO 2009/023553 A1 describes hot-melt adhesives based on silane functional polymers that are liquid at room temperature as well as silane functional polymers that can contain in addition silane-based adhesion tackiness improving agents. Silane functional polymers that are preferred in the context of this disclosure are acrylate modified polyethers that are liquid at room temperature and are reacted, for example, with acrylate copolymers that contain free carboxy groups.

However, in the case of the above-described systems, the very short open time is a problem and it is in conflict with a use of the composition as lamination adhesives without an interim reactivation (i.e., remelting). Moreover, such hot-melt adhesives have an excessively high viscosity, so that they are not suitable for textile laminations, particularly in the clothing sector.

In order to improve the properties of silane grafted poly-α-olefins, in particular in order to increase the open time and/or reduce the viscosity, it is possible to add additives, such as oils or butadienes. However, these components reduce the cross-linking density of the adhesives, which results in a lower heat resistance. Consequently, it is no longer possible to guarantee a sufficient and permanent wash resistance of textiles. An additional problem of viscosity-reducing additives is that they are released over time from the adhesive. This is a problem particularly in the bonding of cotton. An additional approach to improving the open time is described in EP 2 113 545 A1, which discloses the addition of a low molecular weight soft resin to silane-grafted poly-α-olefins. However, the disadvantage of this compound is that, during the curing of the adhesive, it is also not incorporated in the developing network and can be released from the adhesive over time. The additional soft resin therefore has to be added in relatively large quantities in the range from 20 to 40 wt %.

### Representation of the Invention

Therefore, there is a demand for reactive hot-melt adhesive compositions that, on the one hand, do not contain ingredients that require labeling, such as monomeric isocyanates, for example, and, on the other hand, have a low viscosity and a long open time, and yield products with high heat resistance and particularly a permanent wash resistance.

This problem is solved surprisingly by a hot-melt composition according to claim 1, which comprises a) at least one thermoplastic poly-α-olefin (P) that is solid at 25° C. and that contains silane groups, b) at least one soft resin (SR) having a melting point or softening point between −10° C. and 40° C.; and c) at least one silane that is liquid at 25° C.

The hot-melt composition according to the invention is associated, on the one hand, with a reduction of the viscosity before the processing, and, on the other hand, with a longer open time. The liquid silane is incorporated in the polymer network during the curing of the composition and therefore it cannot escape from the adhesive bond over the lifespan of a manufactured product. In addition, the adhesive-melt composition according to the invention has the same advantageous properties as compositions without the silane that is liquid at 25° C., i.e., they have a broad adhesion spectrum and result in bonding capable of withstanding high loads and are exceedingly heat stable. In the case of adhesive bonds that are composed of such hot-melt adhesive compositions, a highly reduced creep behavior can be observed. Finally, hot-melt adhesive compositions according to the invention are highly advantageous with regard to their aspects pertaining to occupational hygiene and safety.

Additional aspects of the invention cover the use of the hot-melt adhesive composition according to the invention for gluing films, foams or textiles, and in particular for gluing thin polyurethane membranes in the textile sector, for gluing glass, in particular in the automobile sector, and for manufacturing sandwich elements, in particular in construction and mobile home sector. A further aspect of the present invention is a composite comprising a first substrate, a second substrate as well as a layer of a hot-melt adhesive composition according to the invention applied in between, as well as a method for manufacturing such a composite.

### Ways of Carrying Out the Invention

In a first aspect, the present invention relates to a hot-melt adhesive composition comprising a) at least one thermoplastic poly-α-olefin (P) that is solid at 25° C. and that contains silane groups, b) at least one soft resin (SR) having a melting point or softening point between −10° C. and 40° C.; and c) at least one silane that is liquid at 25° C.

It is preferable for the thermoplastic poly-α-olefin (P) that is solid at 25° C. and that contains silane groups to be a silane-grafted poly-α-olefin (P).

It is preferable for the poly-α-olefin (P) that contains silane groups to have a softening temperature between 70° C. and 150° C., in particular between 80° C. and 120° C., and particularly preferably between 90° C. and 110° C.

The softening point is measured here using the ring & ball method based on DIN EN 1238.

Such poly-α-olefins (P) that contain silane groups are known to the person skilled in the art. They can be produced, for example, by grafting unsaturated silane, such as vinyl trimethoxysilane, to a poly-α-olefin. A detailed description of the production of silane-grafted poly-α-olefins can be found in U.S. Pat. No. 5,994,474 and DE 40 00 695 A1, for example.

A silane-grafted polyethylene or polypropylene is particularly suitable as solid poly-α-olefin (P) that contains silane groups.

Additional preferred poly-α-olefins (P) that contain silane groups are silane-grafted poly-α-olefins, which are poly-α-olefins manufactured by means of metallocene catalysts to which silane groups have been grafted. In particular, they are silane-grafted polyolefin homopolymers or polypropylene homopolymers.

The grafting degree of the silane-grafted poly-α-olefin (P) is advantageously more than 1 wt %, in particular more than 3 wt % silane, relative to the weight of the polyolefin. If a silane-grafted poly-α-olefin (P) produced according to the Ziegler-Natta method is used as silane-grafted poly-α-olefin (P), then the grafting degree is preferably between 1 and 8 wt %, in particular between 1.5 and 5 wt %. If poly-α-olefins produced using metallocene catalysts are used as the silane-grafted poly-α-olefin, the grafting degree is preferably between 8 and 12 wt %.

It is particularly advantageous if the hot-melt adhesive composition according to the invention has at least two different poly-α-olefins (P) that contain silane groups. The combination of silane-grafted poly-α-olefins that can be obtained by the Ziegler-Natta method and of silane-grafted polypropylene homopolymers that can be obtained by the metallocene catalyst method is particularly preferable.

In a preferred embodiment, the content of all the poly-α-olefins (P) that contain silane groups in the hot-melt adhesive composition is more than 40 wt %, and in particular it is between 45 and 75 wt %.

The hot-melt adhesive composition according to the invention moreover contains at least one soft resin (SR) having a melting point or softening point between −10° C. and 40° C., preferably between 0° C. and 25° C., and in particular between 10° C. and 25° C. Due to the fact that the soft resin (SR) at room temperature (25° C.) is very close to the melting or softening point, it is either already liquid or very soft at room temperature. The soft resin can be a natural resin or a synthetic resin.

In particular, such soft resins (SR) are resins having a medium to high molecular weight from the classes of the paraffin resins, hydrocarbon resins, polyolefins, polyesters, polyethers, polyacrylates or amino resins. In a preferred embodiment, the soft resin (SR) is a hydrocarbon resin, in particular an aliphatic C₅-C₉ hydrocarbon resin. An aliphatic C₅ hydrocarbon resin that is commercially marketed under the trade name Wingtack® 10 by the company Cray Valley is particularly suitable as soft resin (SR).

Additional soft resins are, for example, polyterpene resins that are commercially marketed, for example, as Sylvares® TR A25 by Arizona Chemical, USA, and rosin esters and tall oil resin esters that are commercially marketed, for example, as Sylvatac® RE 12, Sylvatac® RE 10, Sylvatac° RE 15, Sylvatac RE 20, Sylvatac® RE 25 or Sylvatac® RE 40 by Arizona Chemical, USA.

An additional advantageous soft resin is Escorez™ 5040 (Exxon Mobil Chemical).

Hydrocarbon resins that are suitable as soft resins are, for example, Picco A10 (Eastman Kodak) and Regalite R1010 (Eastman Kodak).

The content of the soft resin component (SR) is preferably approximately 5 to 35 wt %, in particular approximately 15 to 25 wt %, relative to the total weight of the hot-melt adhesive composition. In addition, it has been found to be particularly advantageous if the weight ratio of the soft resin component (SR) to the component consisting of poly-α-olefins (P) that contain silane groups is less than 0.5. The weight ratio is preferably in the range of approximately 0.2 to 0.4, and particularly preferably in the range of approximately 0.3 to 0.4.

The silane that is liquid at 25° C. comprises silane compounds in which the silane contains at least one silyl alkoxy functionality. During the curing of the hot-melt adhesive composition such siloxane groups hydrolyze first, releasing alcohols to form silanols which, with splitting off of water, can react with additional silanol groups in the hot-melt adhesive composition. Such silanol groups are also formed inter alia during the hydrolysis of the silane groups in the poly-α-olefin that contains silane groups, so that the silane that is liquid at room temperature is bound covalently to the poly-α-olefin that contains silane groups, in the hardened composition.

The silane that is liquid at 25° C. preferably has at least two alkoxy functionalities bound to silicon, since, as a result, it is possible to increase the crosslinking in the resulting completely cured hot-melt adhesive composition. In particular, the silane that is liquid at 25° C. has three alkoxy functionalities bound to silicon, which results in a particularly effective crosslinking and a high initial strength of the adhesive. In a particularly preferred embodiment, the silane that is liquid at 25° C. is an alkyltrialkoxysilane, in which the alkyl group preferably has 6 to 24 carbon atoms and each alkoxy group preferably has 1 to 5 carbon atoms. In a quite particularly preferred embodiment, the silane that is liquid at 25° C. is hexadecyltrimethoxysilane.

The silane that is liquid at 25° C. preferably also has as high as possible a boiling temperature, so that it is not released during the heating of the hot-melt adhesive into the environment. The boiling temperature of the silane is preferably at least 130° C., particularly preferably at least 150° C., and in particular at least 180° C.

The weight proportion of the silane that is liquid at 25° C. is preferably approximately 3 to 20 wt %, in particular approximately 5 to 15 wt %, and particularly preferably approximately 6 to 12 wt %, relative to the total weight of the hot-melt adhesive composition.

It can be advantageous for the hot-melt adhesive composition according to the invention to contain, in addition to the poly-α-olefin (P) that contains silane groups, an additional thermoplastic poly-α-olefin (P′) that is solid at 25° C. This polymer can be a homopolymer or copolymer of unsaturated monomers, in particular from the group comprising ethylene, propylene, butylene, isobutylene, isoprene, vinyl acetate or vinyl esters with C3 to C12 carboxylic acids and (meth)acrylate. Ethylene vinyl acetate (EVA), atactic poly-α-olefins (APAO), in particular an atactic or an amorphous poly-α-olefin (APAO), polypropylene and polyethylene are particularly preferable. Atactic poly-α-olefins are quite particularly preferable.

The solid thermoplastic polymers (P′) preferably have a softening point of more than 90° C., in particular between approximately 90 and 130° C.

The molecular weight Mn is preferably between approximately 7000 and 250,000 g/mol.

It can be advantageous to use metallocene catalysts for the production of the atactic poly-α-olefins (P′).

The weight ratio of the solid poly-α-olefins (P) that contain silane groups to the solid thermoplastic polymer component (P′) is particularly preferably in the range from 1:1 to 20:1. A content of solid thermoplastic polymer (P′) of approximately 5 to 35 wt %, in particular of approximately 10 to 20 wt %, relative to the total weight of the hot-melt adhesive compositions, has been found to be particularly advantageous.

The hot-melt adhesive composition according to the invention moreover contains preferably at least one catalyst which catalyzes the reaction of silane groups, in particular a phosphoric acid ester or an organotin compound, preferably dibutyltin laurate (DBTL). The catalyst is advantageously contained in a quantity of more than 0.05 wt %, in particular in a quantity in the range from approximately 0.1 to 1 wt %, in the hot-melt adhesive composition.

In addition, the hot-melt adhesive compositions according to the invention can contain additional auxiliary substances and additives, particularly those selected from the group comprising plasticisers, adhesive promoters, UV absorption agents, UV and heat stabilizers, optical brighteners, fungicides, pigments, dyes, fillers and desiccants.

It has been found to be particularly advantageous for the weight sums of all the thermoplastic poly-α-olefins (P) that are solid at 25° C. and that contain silane groups and all the soft resins (SR) and all the optionally present solid thermoplastic polymers (P′) to be more than approximately 80 wt %, preferably more than approximately 90 wt %, of the hot-melt adhesive composition.

It has been found to be particularly advantageous to use hot-melt adhesive compositions that consist substantially of a thermoplastic poly-α-olefin (P) that is solid at 25° C. and that contains silane groups, soft resin (SR), at least one silane that is liquid at 25° C., optionally solid thermoplastic polymer (P′), as well as a catalyst that catalyzes the reaction of silane groups.

As described above, the silane groups in the poly-α-olefin (P) that contains silane groups as well as in the silane that is liquid at 25° C. react in contact with water to form silanol groups, which subsequently react with other silanol groups with splitting off of water to form siloxane groups (—Si—O—Si—) and produce a crosslinking of the hot-melt adhesive compositions. Therefore, it is advantageous to use, for the production of the hot-melt adhesive composition according to the invention, raw materials that are dried as well as possible, and that protect the adhesives during production, storage and application to the extent possible from contact with water or atmospheric moisture. However, the addition of silanes that are liquid at 25° C. improves the sensitivity of the adhesive to water, since, as a result of the reaction of the silane with water, at first no crosslinking of the poly-α-olefin that contains silane groups occurs.

In principle, the production is carried out in the manner that is known to the person skilled in the art of hot-melt adhesives.

The hot-melt adhesive compositions according to the invention are liquefied by melting the thermoplastic ingredients. In the process, the viscosity of the hot-melt adhesive compositions should be adapted to the application temperature. Typically, the application temperature at which the adhesive is in a form that can be processed easily is in the range from 90 to 200° C. In this temperature range, the viscosity is approximately 1500 to 50,000 mPa·s. If the viscosity is substantially higher, then the application is difficult, whereas, if the viscosity is substantially lower than 1500 mPa·s, the adhesive becomes so highly fluid that it runs off the material surface to be glued at the time of the application, before solidifying due to cooling.

A particular advantage of the hot-melt adhesive composition according to the invention is that, even at low application temperatures, it has a sufficient viscosity that allows application. Thus, it is preferable for the hot-melt adhesive composition according to the invention to be processed at temperatures in the range from approximately 90 to 130° C., in particular in the range from approximately 100 to 110° C.

The setting and solidification of the hot-melt adhesive that occurs during the cooling results in a rapid build up of strength and a high early adhesive strength of an adhesive bond. When using an adhesive, care must be taken therefore to ensure that the gluing occurs within the time period in which the adhesive has not yet cooled excessively, i.e., the gluing must occur while the adhesive is still liquid or at least still tacky and deformable. In addition to this physical type of solidification, the hot-melt adhesive composition will continue to crosslink and it will gain mechanical strength—within a time period of typically several hours or days —even after cooling, due to the influence of water, particularly atmospheric moisture. In contrast to the nonreactive hot-melt adhesive compositions, the reactive hot-melt adhesive compositions cannot be heated reversibly and liquefy again as a result. Thus, the use of such hot-melt adhesive compositions is advantageous particularly for uses in which the glued composite is exposed to high temperatures during the course of its utilization or lifespan, since the gluing at such temperatures does not incur any damage at such temperatures. Similarly, the use of such hot-melt adhesives is also advantageous in that they undergo significantly less creep due to the crosslinking.

An additional aspect of the invention relates to a composite, comprising a first substrate (S1), which comprises glass, plastic, wood, film, foam or a textile, preferably a textile, a hot-melt adhesive composition as described above, or a hot-melt adhesive composition crosslinked due to the influence of water as described above, as well as a second substrate (S2), wherein the hot-melt adhesive composition or the crosslinked hot-melt adhesive composition is arranged between the first substrate (S1) and the second substrate (S2).

The term film denotes in particular bendable flat films made of polyolefins at a thickness of 0.05 mm to 5 mm, which can be rolled up. Thus, in addition to “films” in the strict sense with thicknesses of less than 1 mm, sealing webs are also used, as are typically used for sealing tunnels, roofs or swimming pools, in a thickness of typically 1 to 3 mm, and in special cases even in a thickness up to a maximum of 5 mm. Such polyolefin films are usually manufactured by spreading, pouring, calendaring or extrusion, and they are typically available commercially in rolls or manufactured on site. They can have a single-layer or multilayer structure. It is clear to the person skilled in the art that polyolefin films can contain additional additives and processing agents, such as fillers, UV and heat stabilizers, plasticisers, anti-friction agents, biocides or flame retardants, antioxidants, pigments such as titanium dioxide or carbon black, for example, and dyes. This means that such films that do not consist of 100% polyolefin are also referred to as polyolefins.

The second substrate (S2), commonly also referred to as a carrier, can be of various types. The substrates can be made, for example, from plastic, in particular polyolefin or ABS, metal, painted metal, wood, wood materials, glass or fiber materials. The substrate is preferably a shaped solid.

In particular, the second substrate (S2) is a fiber material, in particular a natural fiber material. Alternatively, it is preferable for the second substrate to be a polyurethane, in particular a polyurethane membrane. In an additional preferred embodiment, the second substrate (S2) is a polypropylene.

If needed, the surface of the second substrate (S2) can be subjected to a preliminary treatment, thus, in particular, by cleaning or by applying a primer. However, it is preferable not to apply a primer to the second substrate.

The described composite is preferably an industrially manufactured article, in particular a textile article. Alternatively, the article can also be a glass article, in particular for automobile applications. In glass articles, the high content of silane ensures a permanent gluing. In an additional embodiment, the article is a sandwich element, in particular for the construction or mobile home sector. Such sandwich elements as a rule consist of several layers made of plastics, such as, for example, ABS or PVC, a foam, such as XPS or EPS, or of wood layers.

An additional aspect of the present invention covers a method for producing a composite material, as described above. This method comprises the steps of (i) melting the hot-melt adhesive composition according to the invention as described above, (ii) applying the molten hot-melt adhesive composition to a first substrate (S1) which comprises glass, plastic or wood, a film, a foam or a textile, preferably a textile, (iii) optionally heating the first substrate (S1), and (iv) putting the second substrate (S2), preferably a polyurethane membrane, in contact with the applied molten hot-melt adhesive composition.

Heating the film (S1) makes the film soft and able to adapt to the geometry of the carrier, without any folds forming.

The polyolefin films used here can be decorative films that have a surface structure. This surface structure can be imprinted, for example, before, during or after gluing.

It is particularly advantageous here to apply the adhesive composition directly on the polyolefin film and not on the carrier, as is the case, for example, with polyurethane dispersion adhesives.

Thus, the contacting step occurs in particular with a contact pressure in particular between 0.1 bar and 1 bar, preferably of at least 0.8 bar (corresponding to the application of a vacuum of up to 0.9 bar, particularly of at least 0.2 bar).

The contact pressure is generated preferably by applying a negative pressure in the space between the second substrate (S2) and the polyolefin film (S1). The above-mentioned contact pressure therefore is generated in particular by the application of a negative pressure of up to 0.9 bar, preferably of at least 0.2 bar. In the case of textile gluing, on the other hand, the application of a negative pressure is not necessary, since here the coated substrate and the substrate to be laminated are preferably compressed together using a calendering roll.

The contacting step occurs preferably at a hot-melt adhesive temperature of 50° C. or more, in particular at a temperature between approximately 50 and 200° C., particularly preferably between approximately 90 and 120° C.

In the case of press laminating methods, the molten hot-melt adhesive composition is applied either on the carrier and/or the surface of the foam or textile. The gluing of the carrier to the foam or textile occurs in any case under the influence of heat by joining and pressing.

The hot-melt adhesive composition according to the invention is characterized, on the one hand, by the absence of isocyanates, which entails advantages with regard to occupational hygiene and safety. In addition, even at low application temperatures, such as from approximately 100 to 110° C., it has a viscosity that is suitable for application, which allows its use in particular for gluing heat-sensitive substances, such as polyurethane membranes, for example.

In addition, the hot-melt adhesive composition according to the invention, in spite of having on average a lower content of soft resin in comparison to EP 2 113 545, has a longer open time, which makes it unnecessary to use the “reactivation” or remelting of the adhesive, which is commonly required in the prior art, before the joining of the surface of the joining partner. This leads to a greatly simplified gluing process, as a result of which the hot-melt adhesive composition according to the invention is also advantageous financially.

The hot-melt adhesive composition according to the invention is exceedingly stable during storage and it has special processing properties, particularly in the application temperature range from approximately 0° C. to 130° C. At these temperatures, the hot-melt adhesive composition according to the invention also has a stable viscosity over a longer time. The hot-melt adhesive composition according to the invention is moreover odor-free, and even if applied in thick layers it is free of bubbles and can be processed rapidly, and it is characterized by a satisfactory adhesion and a satisfactory resistance to environmental influences, in particular to textile washing processes, for example.

Below, the invention is illustrated using an example.

### EXAMPLES

A hot-melt adhesive composition was prepared, in which the starting substances were mixed in accordance with the weight contents indicated in Table 1 at a temperature of 150° C. and under an inert gas atmosphere in a stirring device.

TABLE 1
Hot-melt adhesive composition

| | 1 | |
|---|---|---|
| P1 | 49.5 | wt % |
| P2 | 7.6 | wt % |
| P3 | 15.2 | wt % |
| Wingtack ® 10 | 19.0 | wt % |
| Hexadecyltrimethoxysilane | 8.4 | wt % |
| Phosphate ester based on long-chain alcohols | 0.33 | wt % |
| Open time (sec) | 230 | sec |

| | |
|---|---|
| Viscosity* at 110° C. (Pa · s) | 8500 |
| Viscosity* at 130° C. (Pa · s) | 4100 |
| Early resistance buildup σₘₐₓ (3 min) [N/mm²] | 0.01 |
| Early resistance buildup σₘₐₓ (6 min) [N/mm²] | 0.03 |
| Early resistance buildup σₘₐₓ (10 min) [N/mm²] | 0.12 |
| Early resistance buildup σₘₐₓ (20 min) [N/mm²] | 0.16 |
| Early resistance buildup σₘₐₓ (30 min) [N/mm²] | 0.17 |
| Elongation at break [%] | 122 |
| Tensile strength [N/mm²] | 0.8 |

*Viscosity at 2.5 rpm

The polymers used can be found in Table 2.

TABLE 2
Polymers used

| | |
|---|---|
| P1 | Silane-grafted poly-α-olefin, |
| | Molecular weight (Mn): 10,600 g/mol, |
| | Melt viscosity (190° C., DIN 53 019): 5000 mPa · s, |
| | Softening temperature (ring & ball): 98° C. |
| P2 | Silane-grafted poly(propylene/ethylene) (Poly-α-olefin) (prepared by |
| | metallocene catalysis) |
| | Melt viscosity (170° C. DIN 53 018): approximately 100 mPa · s, |
| | Softening temperature (ring & ball): 100° C. |
| | Dropping point: approximately 80° C. |
| | Density: approximately 0.90 g/cm³ |
| | Silane content: approximately 10 wt % (grafting agent: |
| | vinyltriethoxysilane) |
| P3 | Amorphous poly-α-olefin (butene-rich) |
| | Melt viscosity (170° C.) |
| | 6000 to 10,000 cp |
| | Density 0.90 g/cm³ |
| | Softening temperature (ring & ball): 114 to 122° C. |
| | Tg: −27° C. |

1. Hot-melt adhesive composition comprising
a) at least one thermoplastic poly-α-olefin (P) that is solid at 25° C. and contains silane groups,
b) at least one soft resin (SR) having a melting point or softening point between 10° C. and 40° C.; and
c) at least one silane that is liquid at 25° C.

2. Hot-melt adhesive composition according to claim 1, wherein the poly-α-olefin (P) that is solid at 25° C. and that contains silane groups has a softening temperature between 70 and 150° C.

3. Hot-melt adhesive composition according to claim 1, wherein the poly-α-olefin (P) that is solid at 25° C. and that contains silane groups is a silane-grafted poly-α-olefin (P).

4. Hot-melt adhesive composition according to claim 1, wherein the poly-α-olefin (P) that is solid at 25° C. and that contains silane groups is a poly-α-olefin manufactured using metallocene catalysts and to which silane groups have been grafted.

5. Hot-melt adhesive composition according to claim 1, wherein the composition comprises at least two different solid poly-α-olefins (P) that contain silane groups.

6. Hot-melt adhesive composition according to claim 1, wherein soft resin (SR) has a melting point or softening point between 0 and 25° C.

7. Hot-melt adhesive composition according to claim 1, wherein the soft resin (SR) is a hydrocarbon resin.

8. Hot-melt adhesive composition according to claim 1, wherein the quantity of soft resin (SR) is 10 to 40 wt %, relative to the hot-melt adhesive composition.

9. Hot-melt adhesive composition according to claim 1, wherein the weight ratio of all the soft resins (SR) to all the solid poly-α-olefins (P) that are solid at 25° C. and that contain silane groups is smaller than 0.5.

10. Hot-melt adhesive composition according to claim 1, wherein the silane that is liquid at 25° C. is an alkyltrialkoxysilane.

11. Hot-melt adhesive composition according to claim 1, wherein the quantity of silane that is liquid at 25° C. is 5 to 15 wt %, relative to the hot-melt adhesive composition.

12. Hot-melt adhesive composition according to claim 1, wherein the composition moreover contains a thermoplastic poly-α-olefin (P′) that is solid at 25° C.

13. A method for gluing films, foams or textiles, comprising:
applying the hot-melt adhesive composition according to claim 1.

14. Composite (1) comprising
a first substrate (S1), which comprises glass, wood, a film, a foam or a textile,
a hot-melt adhesive composition according to claim 1 or the hot-melt adhesive composition crosslinked due to the influence of water as well as
a second substrate (S2),
wherein the hot-melt adhesive composition or the cross-linked hot-melt adhesive composition is arranged between the first substrate (S1) and the second substrate (S2).

15. Composite according to claim 14, wherein the second substrate (S2) is a fiber material, or a polyurethane membrane.

16. Composite according to claim 15, wherein the second substrate (S2) is a polypropylene.

17. Method for preparing a composite according to claim 14, comprising the steps:
(i) melting the hot-melt adhesive composition,
(ii) applying the molten hot-melt adhesive composition on a first substrate (S1), which comprises glass, plastic, wood, a film, a foam or a textile,
(iii) optionally heating the first substrate (S1), and
(iv) putting the second substrate, (S2), in contact with the molten hot-melt adhesive composition.

18. Method according to claim 17, wherein the contacting step is carried out under a contact pressure.
